(19) United States
(12) Patent Application Publication
(10) Pub. No.: US 2026/0230014 A1
(43) Pub. Date: Aug. 6, 2026

(54) MOTOR DRIVE CONTROL DEVICE AND MOTOR DRIVE CONTROL METHOD

(71) Applicant: MINEBEA MITSUMI Inc., Kitasaku-gun, Nagano (JP)

(72) Inventors: Hidetoshi HIJIKATA, Kitasaku-gun, Nagano (JP); Hiroki KOKUBO, Kitasaku-gun, Nagano (JP); Shinji TOTSUKA, Kitasaku-gun, Nagano (JP); Shigemi MASUDA, Kitasaku-gun, Nagano (JP)

(21) Appl. No.: 19/149,885

(22) PCT Filed: Dec. 22, 2023
(86) PCT No.: PCT/JP2023/046083

§ 371 Date: Jul. 22, 2025

(30) Foreign Application Priority Data
Jan. 24, 2023 (JP) 2023-008805

(51) Int. Cl. H02P 6/17; H02P 6/18

(52) U.S. Cl. CPC H02P 6/17; H02P 6/18

(57) ABSTRACT

A motor drive control device capable of accurately detecting the presence or absence of an idling state of a motor in a short time is provided. The motor drive control device includes: a control circuit configured to generate a drive control signal; a drive circuit including an inverter circuit including switches provided corresponding to each phase of coil of a motor, the drive circuit being configured to rotate a rotor of the motor by alternately turning on and off the switches in response to the drive control signal; and a shunt resistor provided between the inverter circuit and the ground. The control circuit generates an idling control signal and switches a switch state of the inverter circuit to generate a current circulating between each phase of coil of the motor and the inverter circuit when the rotor of the motor is idling, and then determines that the motor is idling based on a current flowing through the shunt resistor due to an inductive kickback generated when a path of the current is blocked.

### TECHNICAL FIELD

The present invention relates to a motor drive control device and a motor drive control method.

### BACKGROUND ART

Generally, in a motor (hereinafter also referred to as “fan motor”) used for a fan for cooling the inside of an electronic device such as a server, even though the motor is not driven by a drive circuit for driving the motor, the motor may be in a state of rotation, so-called idling state, due to inertia or the action of external force.

Patent Document 1 describes a method for detecting the idling state of a rotor of the motor. This method, upon energizing predetermined switching elements among a plurality of switching elements constituting an inverter circuit of a motor, allows detection of a rotation speed of a fan of an outdoor unit in the idling state due to external force even when an air conditioner is stopped, by extracting a rotation speed of the motor based on currents flowing through current detection resistors.

### CITATION LIST

### Patent Literature

Patent Document 1: JP 2018-170928 A

### SUMMARY OF INVENTION

### Technical Problem

However, although the method described in Patent Document 1 detects the rotation speed of the motor in the idling state, it may be only required to detect the presence or absence of the idling state of the motor in a short time without detecting the rotation speed of the idling motor. For example, when a rotor of a motor is idling, an induced voltage is generated in a coil (winding) of the motor, and when the coil of the motor and an inverter circuit form a closed circuit, an induced current is generated in the coil of the motor. Therefore, it is necessary to perform winding resistance measurement, initial rotor position detection, and the like using a current flowing through a shunt resistor by energizing the coil of the motor, when the motor is not idling. Thus, the presence or absence of the idling state of the motor can be used as a determination index for executing various processing.

In addition, the presence or absence of the idling state of the motor can be easily detected by using a position sensor. However, if the presence or absence of the idling state of the motor can be detected without using the position sensor, it is preferable from the standpoint of simplifying the device configuration.

Similarly, the presence or absence of the idling state of the motor can be easily detected by measuring an induced voltage generated in each phase of coil of the motor using a comparator, an A/D converter, or the like. However, if the presence or absence of the idling state of the motor can be detected without using a measurement circuit for each phase voltage, it is preferable from the standpoint of simplifying the device configuration.

Thus, a motor drive control device capable of detecting the presence or absence of an idling state of a motor with a simple configuration without using a position sensor or a measurement circuit for each phase voltage is desired.

To solve the above problem, an object of the present invention is to provide a motor drive control device capable of accurately detecting the presence or absence of an idling state of a motor in a short time without using a position sensor or a measurement circuit for each phase voltage.

### Solution to Problem

A motor drive control device according to a representative embodiment of the present invention includes:
a control circuit configured to generate a drive control signal for driving a motor including at least one phase of coil;
a drive circuit including an inverter circuit including a high-side switch and a low-side switch, the high-side switch and the low-side switch being provided corresponding to each phase of coil of the motor and connected in series with each other, the drive circuit being configured to rotate a rotor of the motor by alternately turning on and off the high-side switch and the low-side switch in response to the drive control signal and thus switching an energization direction of the corresponding phase of coil; and
a shunt resistor provided between the inverter circuit and a ground, in which
the control circuit generates an idling control signal instead of the drive control signal and switches a switch state of the inverter circuit, and thus generates an induced current circulating between each phase of coil of the motor and the inverter circuit when the rotor of the motor is idling, and then determines that the motor is idling, based on a current flowing through the shunt resistor due to an inductive kickback generated in the inverter circuit when a path of the induced current is blocked.

### Advantageous Effects of Invention

An aspect of the present invention enables a motor drive control device 10 to accurately detect the presence or absence of an idling state of a motor in a short time without using a position sensor or a measurement circuit for each phase voltage.

### BRIEF DESCRIPTION OF DRAWINGS

FIG. 1 is a diagram illustrating a configuration of a motor unit 100 including a motor drive control device 10 according to an embodiment.

FIG. 2 is a diagram for explaining a switch state corresponding to a free mode, the free mode being switched by an idling control signal Id.

FIG. 3 is a diagram for explaining a switch state corresponding to a charging mode, the charging mode being switched by the idling control signal Id.

FIG. 4 is a diagram for explaining a switch state corresponding to a discharge mode, the discharge mode being switched by the idling control signal Id.

FIG. 5 is a diagram for explaining another switch state corresponding to the charging mode, the charging mode being switched by the idling control signal Id.

FIG. 6 is a diagram for explaining a switch state, the switch state not entering the charging mode even when switched by the idling control signal Id.

FIG. 7 is a diagram illustrating an example of a configuration of a current detection circuit 2c of the motor drive control device 10.

FIG. 8 is a diagram illustrating an example of a configuration of a current measurement unit 16 included in a control circuit 1 of the motor drive control device 10.

FIG. 9 is a diagram illustrating a functional block configuration of the control circuit 1 in the motor drive control device 10 according to the embodiment.

FIG. 10 is a diagram illustrating a relationship between a rotation speed of a motor 3 and a current measurement value measured by a current measurement unit 16, the current flowing through a shunt resistor Rs due to an inductive kickback during charging times (periods corresponding to the charging mode) of 10 msec and 50 msec when a rotor of the motor 3 is idling in a low-speed range.

FIG. 11 is a diagram illustrating the relationship between the rotation speed of the motor 3 and the current measurement value measured by the current measurement unit 16, the current flowing through the shunt resistor Rs due to the inductive kickback during charging times (periods corresponding to the charging mode) of 10 msec and 50 msec when the rotor of the motor 3 is idling in a high-speed range.

FIG. 12 is a timing chart illustrating an example of a signal waveform from input of a speed command signal Sc to completion of idling determination when the rotor of the motor 3 is not moving at all.

FIG. 13 is a timing chart illustrating an example of a signal waveform from the input of the speed command signal Sc to the completion of idling determination when the rotor of the motor 3 is moving.

FIG. 14 is a flowchart illustrating an example of the flow of processing upon power-on in the control circuit 1 of the motor drive control device 10 according to the embodiment.

FIG. 15 is a flowchart illustrating an example of the flow of offset measurement processing by the control circuit 1 of the motor drive control device 10.

FIG. 16 is a flowchart illustrating an example of the flow of idling detection processing of a motor by the control circuit 1 of the motor drive control device 10.

### DESCRIPTION OF EMBODIMENTS

### 1. Overview of Embodiments

First, a representative embodiment of the invention disclosed in the present application will be overviewed. Note that, in the following description, as an example, reference signs in the drawings corresponding to components of the present invention are indicated in parentheses.
[1] A motor drive control device (10) according to a representative embodiment of the present invention, includes:
   a control circuit (1) configured to generate a drive control signal (Sd) for driving a motor including at least one phase of coil;
   a drive circuit (2) including an inverter circuit (2a) including high-side switches (Q1, Q3, Q5) and low-side switches (Q2, Q4, Q6), the high-side switches and the low-side switches being provided corresponding to respective phases of coils of the motor (3) and connected in series with each other, the drive circuit being configured to rotate a rotor of the motor by alternately turning on and off the high-side switches and the low-side switches in response to the drive control signal to switch an energization direction of the corresponding phase of coil; and
   a shunt resistor (Rs) provided between the inverter circuit and a ground, wherein
   the control circuit generates an idling control signal (Id) instead of the drive control signal and switches a switch state of the inverter circuit to generate an induced current circulating between each phase of coil of the motor and the inverter circuit when the rotor of the motor is idling, and then determines that the motor is idling, based on a current flowing through the shunt resistor due to an inductive kickback generated in the inverter circuit when a path of the induced current is blocked.
[2] The motor drive control device according to above [1], wherein the control circuit may include: a first switching unit (21a) configured to switch from a first switch state with all of the high-side switches and the low-side switches included in the inverter circuit turned off to a second switch state with at least two of either the high-side switches or the low-side switches included in the inverter circuit turned on; a second switching unit (21b) configured to switch from the second switch state to the first switch state; and an idling determination unit (22) configured to determine that the motor is idling, based on the current flowing through the shunt resistor when switching from the second switch state to the first switch state is performed.
[3] The motor drive control device according to above [2], wherein the second switching unit may switch from the second switch state to the first switch state when a time ten times a time constant defined by a winding resistance and an inductance of the motor elapses.
[4] The motor drive control device according to above [2] or [3], wherein after switching from the second switch state to the first switch state, the second switching unit may maintain the first switch state for a time until the current flowing through the shunt resistor due to the inductive kickback becomes a maximum current in an inverter circuit direction from the ground toward the inverter circuit or for a time equal to or more than 0.5 times a time constant defined by a winding resistance and an inductance of the motor.
[5] The motor drive control device according to above [4], wherein the control circuit may determine that the motor is idling when the maximum current flowing through the shunt resistor in the inverter circuit direction due to the inductive kickback exceeds a predetermined threshold value.
[6] The motor drive control device according to above [4], further including a current detection circuit (2c) including the shunt resistor and a bidirectional current detection circuit capable of detecting the current flowing through the shunt resistor in both a ground direction from the inverter circuit toward the ground and the inverter circuit direction, wherein the control circuit may further include a current measurement unit (16) configured to detect in advance, as an offset, a signal output from the current detection circuit while no current flows through the shunt resistor, to adjust, with the offset, a signal output from the current detection circuit in determination of the idling, and to output the signal to the idling determination unit.
[7] A method for detecting idling of a motor according to a representative embodiment of the present invention is a method for detecting idling of a motor to be executed in a motor drive control device, the motor drive control device including: a control circuit configured to generate a drive control signal for driving a motor including at least one phase of coil; a drive circuit including an inverter circuit including a high-side switch and a low-side switch, the high-side switch and the low-side switch being provided corresponding to each phase of coil of the motor and connected in series with each other, the drive circuit being configured to rotate a rotor of the motor by alternately turning on and off the high-side switch and the low-side switch in response to the drive control signal to switch an energization direction of the corresponding phase of coil; and a shunt resistor provided between the inverter circuit and a ground, the method including a first step of switching from a first switch state with all of the high-side switches and the low-side switches included in the inverter circuit turned off to a second switch state with at least two of either the high-side switches or the low-side switches included in the inverter circuit turned on; a second step of switching from the second switch state to the first switch state; and a third step of determining that the motor is idling, based on a current flowing through the shunt resistor when switching to the first switch state is performed.

### 2. Specific Examples of Embodiments

Specific examples of embodiments of the present invention will be described below with reference to the drawings. In the following description, the same reference signs are used for common components in the respective embodiments, and repeated descriptions will be omitted.

### Embodiments

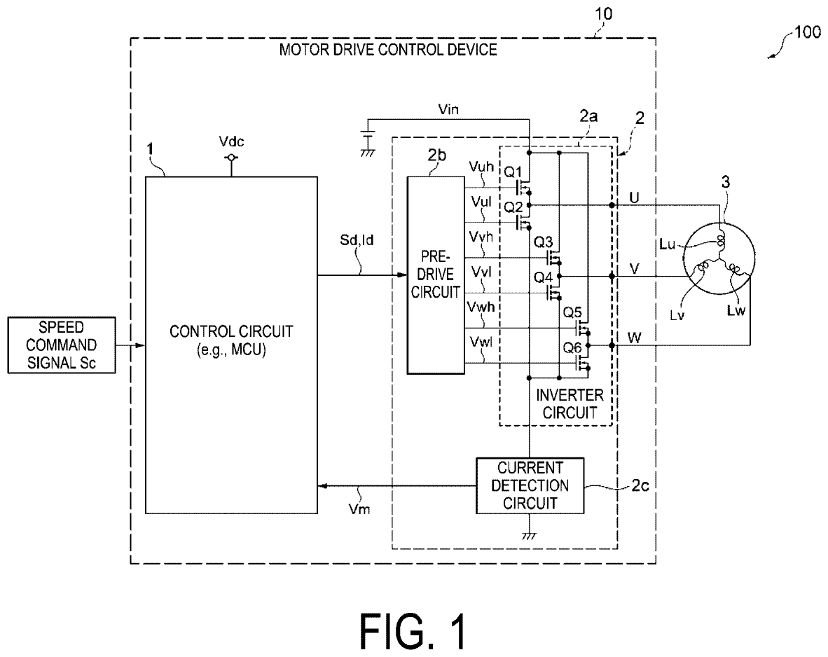

FIG. 1 is a diagram illustrating a configuration of a motor unit 100 including a motor drive control device 10 according to the embodiment.

As illustrated in FIG. 1, the motor unit 100 includes a motor 3 and the motor drive control device 10 for controlling rotation of the motor 3. The motor unit 100 can, for example, be applied to various devices using the motor as a driving source, such as a fan.

The motor 3 is a permanent magnet synchronous motor (PMSM), for example. In the present embodiment, the motor 3 is a surface permanent magnet synchronous motor (SPMSM) including three-phase coils (windings) Lu, Lv, and Lw, for example. The coils Lu, Lv, and Lw are Y (star)-connected to each other. In this case, the coils may also be Δ (delta)-connected to each other.

The motor drive control device 10 rotates a rotor of the motor 3 by periodically applying a sinusoidal drive current to the three-phase coils Lu, Lv, and Lw of the motor 3 by providing sinusoidal drive signals to the motor 3, for example.

The motor drive control device 10 includes a control circuit 1 and a drive circuit 2.

Note that the components of the motor drive control device 10 illustrated in FIG. 1 are part of the whole, and the motor drive control device 10 may include other components in addition to the components illustrated in FIG. 1.

The drive circuit 2 drives the motor 3 based on a drive control signal Sd output from the control circuit 1 described below. The drive circuit 2 includes, for example, an inverter circuit 2a, a pre-drive circuit 2b, and a current detection circuit 2c.

The inverter circuit 2a is a circuit disposed between a DC power supply Vin and a ground potential and configured to drive the coils Lu, Lv and Lw of the motor 3 as a load, based on the input drive control signal Sd. Specifically, in the embodiment, the inverter circuit 2a includes three switching legs including two drive transistors connected in series, and drives the motor 3 as a load with the two drive transistors alternately performing on/off operation (switching operation) based on the input drive control signal Sd.

More specifically, the inverter circuit 2a includes switching legs corresponding to the U-phase, V-phase, and W-phase of the motor 3, respectively. As illustrated in FIG. 1, the switching legs corresponding to the respective phases include two drive transistors (hereinafter referred to also as “switching elements”) Q1 and Q2, Q3 and Q4, and Q5 and Q6 connected in series via the current detection circuit 2c between the DC power supply Vin and the ground potential.

Here, the drive transistors Q1, Q3 and Q5 (corresponding to the high-side switches) of the upper arms of the coils of the motor 3 are, for example, N-channel MOSFETs, and the drive transistors Q2, Q4 and Q6 (corresponding to the low-side switches) of the lower arms of the coils of the motor 3 are, for example, N-channel MOSFETs. Note that the drive transistors Q1 to Q6 may be other types of FETs, and may be other types of transistors such as an Insulated Gate Bipolar Transistor (IGBT), for example.

For example, the switching leg corresponding to the U-phase includes the switching elements Q1 and Q2 connected in series with each other. The common connection point of the switching element Q1 and the switching element Q2 is connected to one end of the coil Lu as a load. The switching leg corresponding to the V-phase includes switching elements Q3 and Q4 connected in series with each other. The common connection point of the switching element Q3 and the switching element Q4 is connected to one end of the coil Lv as a load. The switching leg corresponding to the W-phase includes the switching elements Q5 and Q6 connected in series with each other. The common connection point of the switching element Q5 and the switching element Q6 is connected to one end of the coil Lw as a load. In addition, the switching elements Q1 and Q2, Q3 and Q4, Q5 and Q6 each have parasitic diode characteristics in a direction from the ground side toward the power supply side (not illustrated in FIG. 1).

The pre-drive circuit 2b generates a drive signal for driving the inverter circuit 2a based on the drive control signal Sd output from the control circuit 1.

The drive control signal Sd is a signal for controlling driving of the motor 3 and is, for example, a Pulse Width Modulation (PWM) signal. Specifically, the drive control signal Sd is a signal for switching an energization pattern of the coils Lu, Lv and Lw of the motor 3 set by the on/off state of each switching element constituting the inverter circuit 2a. More specifically, the drive control signal Sd includes six types of PWM signals corresponding to the switching elements Q1 to Q6 of the inverter circuit 2a.

Based on the six PWM signals as the drive control signal Sd supplied from the control circuit 1, the pre-drive circuit 2b generates six drive signals Vuh, Vul, Vvh, Vvl, Vwh, and Vwl capable of supplying sufficient power to drive control electrodes (gate electrodes) of the respective switching elements Q1 to Q6 of the inverter circuit 2a.

When these drive signals Vuh, Vul, Vvh, Vvl, Vwh, and Vwl are input to the control electrodes (gate electrodes) of the respective switching elements Q1 to Q6 of the inverter circuit 2a, each of the switching elements Q1 to Q6 performs an on/off operation (switching operation). For example, the switching elements Q1, Q3, and Q5 of the upper arms of the switching legs corresponding to respective phases and the switching elements Q2, Q4, and Q6 of the lower arms alternately perform the on/off operation. As a result, the DC power supply Vin supplies power to each phase of the motor 3, and the motor 3 rotates.

The current detection circuit 2c is connected to a DC line of the inverter circuit 2a and detects the current flowing through the DC line. Specifically, the current detection circuit includes one resistor (hereinafter referred to also as “shunt resistor”) Rs serving as a current detection element. The shunt resistor Rs is connected in series to the inverter circuit 2a between the DC power supply Vin and the ground potential, for example. That is, the shunt resistor Rs of the current detection circuit 2c is connected to a negative side (ground side) of the inverter circuit 2a, for example, as illustrated in FIG. 1. During driving of the motor, the inverter circuit 2a is controlled, and currents Iu, Iv, and Iw flowing through the three-phase coils Lu, Lv, and Lw of the motor 3 flow through the shunt resistor Rs of the current detection circuit 2c. The current detection circuit 2c detects a voltage drop, caused by the current flowing through the shunt resistor Rs, from a differential voltage across both ends of the shunt resistor Rs, and outputs, as a detection result, a current detection signal Vm corresponding to the current flowing through the shunt resistor Rs to the control circuit 1.

The motor drive control device 10 of the present embodiment is configured, in addition to driving the motor 3 by the drive control signal Sd, to determine that the motor 3 is idling when the motor 3 is not being driven by the drive control signal Sd during idling detection of the motor.

In the motor drive control device 10 of the present embodiment, it is determined that the motor 3 is idling, based on the current flowing through the shunt resistor due to an inductive kickback, the inductive kickback being generated when a path of the current is blocked after a current circulating between the coils of the motor 3 and the inverter circuit 2a is generated in the case where the rotor of the motor 3 is rotated by switching the switch state of each of the switching elements Q1 to Q6 of the inverter circuit 2a.

In the motor drive control device 10 of the present embodiment, to determine the idling of the motor 3, the drive circuit 2 receives an idling control signal Id different from the drive control signal Sd for driving the motor from the control circuit 1 described below, and switches each switching element constituting the inverter circuit 2a to a switch state for detecting the idling of the motor 3 on the basis of the received idling control signal Id. Specifically, each switching element constituting the inverter circuit 2a is switched to switch states corresponding to three modes (a free mode, a charging mode, and a discharge mode) on the basis of the idling control signal Id. The three modes for detecting the idling of the motor 3 will be described below.

The idling control signal Id is a signal for switching each of the switching elements constituting the inverter circuit 2a to switch states corresponding to the three modes for detecting the idling of the motor 3. The idling control signal Id is different from the drive control signal Sd for driving the motor, and is not a signal for generating a drive voltage in the coils of the motor 3, so the idling control signal Id is not a signal for alternately switching on and off states of each of the switching elements, but a high or low signal having a predetermined length, for example. The idling control signal Id includes six types of signals corresponding to the switching elements Q1 to Q6 of the inverter circuit 2a.

Based on the idling control signal Id output from the control circuit 1, the pre-drive circuit 2b generates a drive signal as a switching signal for switching the switch state of each of the switching elements constituting the inverter circuit 2a.

Based on the six types of signals as the idling control signal Id supplied from the control circuit 1, the pre-drive circuit 2b generates a signal capable of supplying sufficient power to switch the switch states of the control electrodes (gate electrodes) of the respective switching elements Q1 to Q6 of the inverter circuit 2a. When drive signals as these switch signals are input to the control electrodes (gate electrodes) of the respective switching elements Q1 to Q6 of the inverter circuit 2a, the switch state of each of the switching elements Q1 to Q6 is switched.

Now the switch states to be switched by the idling control signal Id and corresponding to the three modes for detecting the idling of the rotor of the motor 3 (the free mode, the charging mode, the discharge mode) are described below.

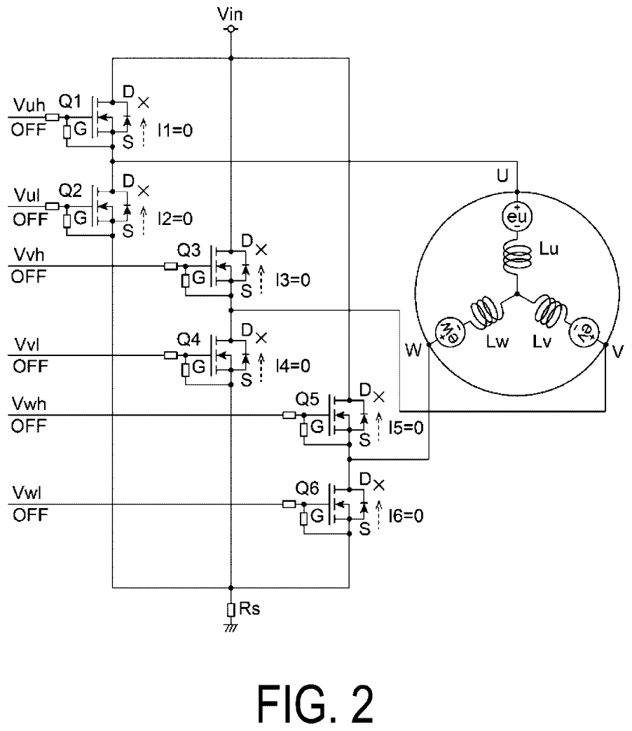

FIGS. 2 to 6 are diagrams for explaining the switch states to be switched by the idling control signal Id, respectively. In FIGS. 2 to 6, the state of the current flowing through the coils of the motor 3 and the inverter circuit 2a when the motor 3 is idling is indicated by arrows. The inverter circuit 2a is connected to the DC power supply Vin and also connected to the ground via the shunt resistor Rs, a part of the current detection circuit 2c.

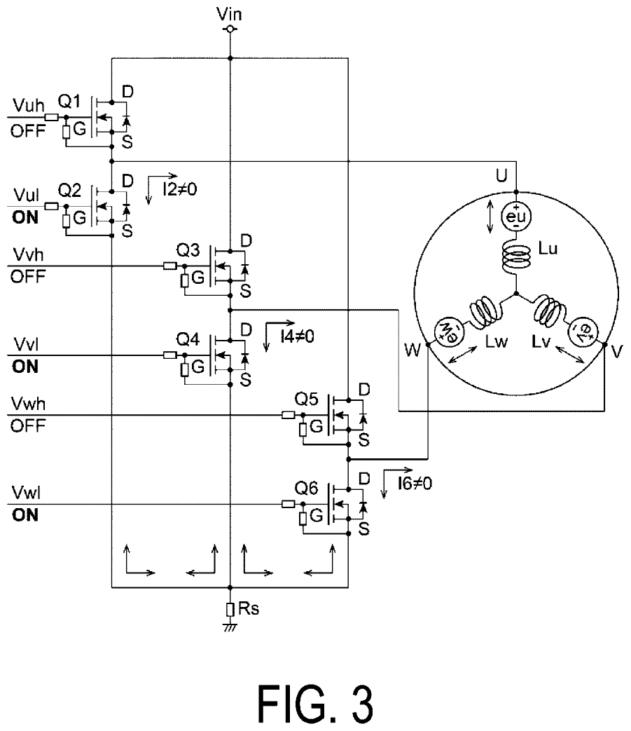

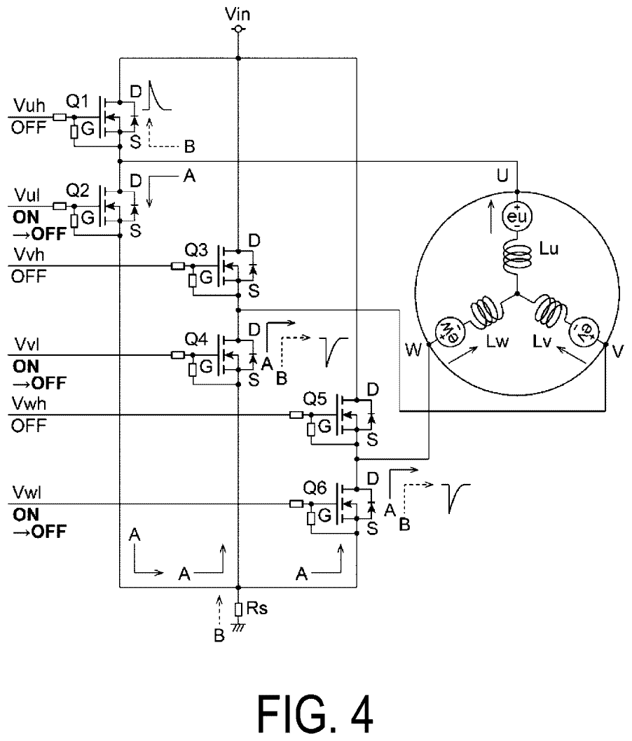

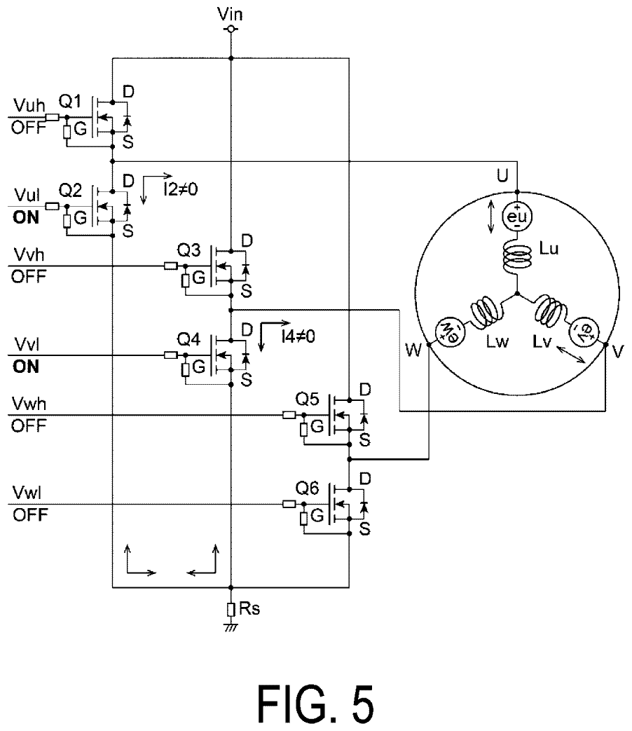

The idling control signal Id is a signal for switching to the corresponding switch state in the order of the free mode (FIG. 2), the charging mode (FIG. 3, FIG. 5), and the discharge mode (FIG. 4). Specifically, the idling control signal Id sets the switch state of the control electrode (gate electrode) of each of the switching elements Q1 to Q6 of the inverter circuit 2a from a first switch state (corresponding to the free mode) illustrated in FIG. 2 to a second switch state (corresponding to the charging mode) illustrated in FIG. 3, and switches the switch state to the first switch state (corresponding to the discharge mode) again as illustrated in FIG. 4, thereby enabling detection of the idling of the motor 3.

### Free Mode

When the idling control signal Id is output from the control circuit 1 by a speed command signal Sc after power-on, the control electrodes (gate electrodes) of the respective switching elements Q1 to Q6 of the inverter circuit 2a are switched to the first switch state by the idling control signal Id output from the control circuit 1. Specifically, as illustrated in FIG. 2, in the inverter circuit 2a, all switch states of the switching elements Q1 to Q6 are switched to off.

As illustrated in FIG. 2, in the first switch state, when the rotor of the motor 3 is idling, an induced voltage is generated in each phase of coil, while the current circulating between the coil of the motor 3 and the inverter circuit 2a is not generated due to each of the switching elements Q1 to Q6 being off and the parasitic diode being clamped. In addition, at this time, no current flows through the shunt resistor Rs.

### Charging Mode

Next, the control electrodes (gate electrodes) of the respective switching elements Q1 to Q6 of the inverter circuit 2a are switched from the first switch state to the second switch state by the idling control signal Id output from the control circuit 1. The second switch state is a switch state where, when the rotor of the motor 3 is idling, an induced voltage is generated in each phase of coil, and the generated current circulates in a closed circuit composed of the coils and switching elements turned on among the switching elements Q1 to Q6. Specifically, in the inverter circuit 2a, the first switch state where all of the switch states of the respective switching elements Q1 to Q6 are off is switched to the second switch state where the switch states of only the switching elements Q2, Q4, and Q6 of the lower arms of the respective switching elements Q1 to Q6 are on, for example, as illustrated in FIG. 3.

As illustrated in FIG. 3, when the second switch state where the switch states of the switching elements Q2, Q4 and Q6 of the lower arms of the switching elements Q1 to Q6 are on is set in the inverter circuit 2a, and the rotor of the motor 3 is idling, an induced current circulating between each phase of coil of the motor 3 and the inverter circuit 2a is generated in the coi due to the induced voltage, and the generated current circulates in a closed circuit composed of the coils and the switching elements Q2, Q4 and Q6 of the lower arms turned on. In addition, at this time, no current flows through the shunt resistor Rs because the shunt resistor Rs is not included in the closed circuit.

Specifically, when the motor is idling, due to the rotation of the rotor relative to the coils, an induced voltage (eu, ev, ew) proportional to the rotation speed is generated in each phase of coil, with polarity in a direction of generating a current preventing a change in magnetic flux, in an electric angle period of the motor rotation with each phase shifted by 120 degrees. At this time, the current waveform has a phase delayed by 90 degrees with respect to the voltage waveform.

### Discharge Mode

Next, the control electrodes (gate electrodes) of the respective switching elements Q1 to Q6 of the inverter circuit 2a are switched from the second switch state to the first switch state again by the idling control signal Id output from the control circuit 1. Specifically, for example, in the inverter circuit 2a, the second switch state where the switch states of the switching elements Q2, Q4, and Q6 of the lower arms of the respective switching elements Q1 to Q6 are on is switched again to the first switch state where all the switch states of the respective switching elements Q1 to Q6 are off, as illustrated in FIG. 4.

As illustrated in FIG. 4, when the rotor of the motor 3 is idling, and the second switch state is switched to the first switch state in the inverter circuit 2a, the path of the induced current circulating is blocked. At this time, in the coils of the windings of the motor 3, an inductive kickback is generated so as to cause the induced current (A in FIG. 4) circulating in the coils to continuously flow. In a short time until voltage variation due to this inductive kickback falls within a voltage range clamped by the parasitic diode of each of the switching elements Q1 to Q6, a voltage rise occurs at the connection point of the upper arm and the lower arm of the leg on the downstream side of the induced current such that a current flows from the coil toward the power supply side via the parasitic diode of the switching element Q1 of the upper arm, and a voltage drop occurs at the connection point of the upper arm and the lower arm of the leg on the upstream side of the induced current such that a current flows from the ground side toward the coils via the parasitic diodes of the switching elements Q4 and Q6 of the lower arms, and, a current (B in FIG. 4) flows from the ground side of the shunt resistor Rs toward the coil side.

In the motor drive control device 10 of the present embodiment, the motor 3 can be determined to be idling when it is determined that a predetermined current has flowed, by detecting the current flowing through the shunt resistor Rs due to the inductive kickback occurring during the discharge mode in the current detection circuit 2c.

Note that in the above-mentioned example, an example case where the switch states of the switching elements Q2, Q4 and Q6 of the lower arms of the respective switching elements Q1 to Q6 of the inverter circuit 2a are on as illustrated in FIG. 3 as the second switch state corresponding to the charging mode is described, but this is not limitative.

The second switch state includes a state where the switch states of any two (Q2 and Q4 in FIG. 5) of the switching elements Q1, Q3 and Q5 of the upper arms or the switching elements Q2, Q4 and Q6 of the lower arms of the respective switching elements Q1 to Q6 are on, as illustrated in FIG. 5. In the switch state illustrated in FIG. 5, when the rotor of the motor 3 is idling, an induced voltage is generated in each phase of coil, and the generated induced current circulates in a closed circuit composed of the coils and the transistors turned on among the switching elements Q1 to Q6. That is, the second switch state can be said to be a switch state where, when the rotor of the motor 3 is idling, an induced voltage is generated in each phase of coil, and the generated induced current circulates at all times in the closed circuit composed of the coils and the transistors turned on among the switching elements Q1 to Q6.

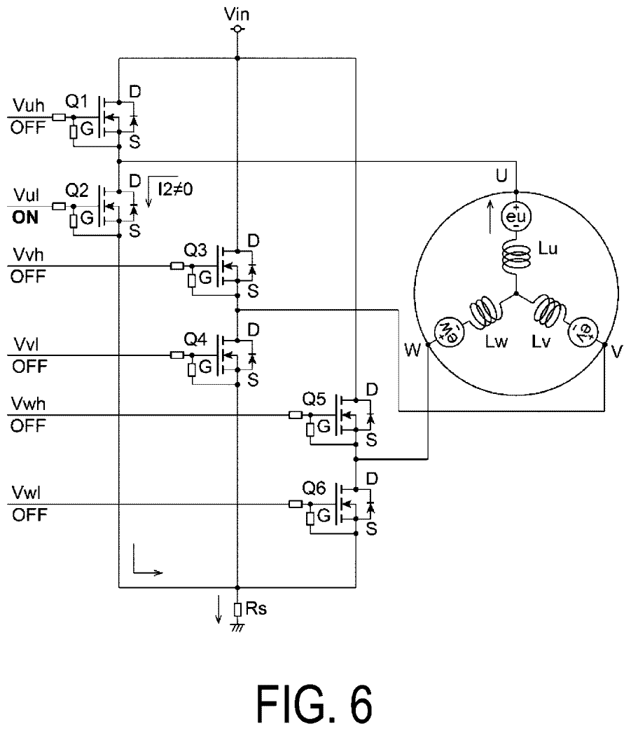

On the other hand, as illustrated in FIG. 6, a case where the switch state of any one (Q2 in FIG. 6) of the switching elements Q1, Q3 and Q5 of the upper arms or the switching elements Q2, Q4 and Q6 of the lower arms of the respective switching elements Q1 to Q6 is on is not included in the second switch state because there is no closed circuit at all times and as a result the induced current does not circulate at all times.

Returning to FIG. 1, the current detection circuit 2c is a circuit for detecting a current flowing through the three-phase coils Lu, Lv, and Lw of the motor 3 when the inverter circuit 2a is controlled during driving of the motor, and detecting a current flowing through the shunt resistor Rs due to an inductive kickback generated when a path of an induced current is blocked after the induced current circulating between the coils Lu, Lv, and Lw of the motor 3 and the inverter circuit 2a is generated, during idling detection of the motor. The current detection circuit 2c outputs a current detection signal Vm corresponding to the current flowing through the shunt resistor Rs to the control circuit 1.

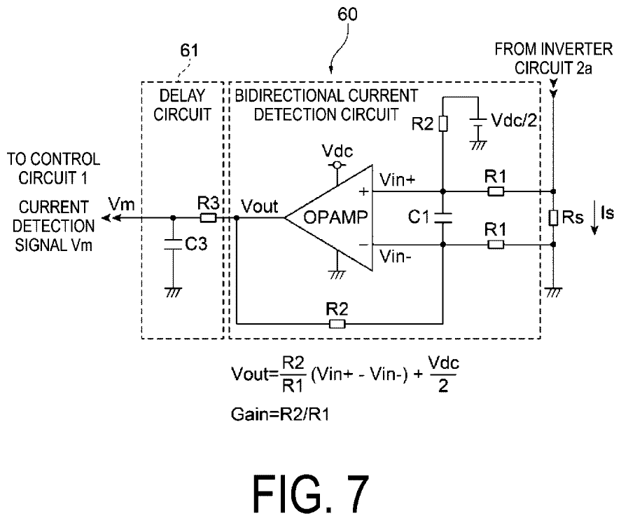

FIG. 7 is a diagram illustrating an example of a configuration of the current detection circuit 2c of the motor drive control device 10. In addition to the shunt resistor Rs, the current detection circuit 2c includes a bidirectional current detection circuit 60 and a delay circuit 61.

The current detection circuit 2c in FIG. 7 outputs the current detection signal Vm corresponding to the current flowing through the shunt resistor Rs.

Specifically, the bidirectional current detection circuit 60 in FIG. 7 acquires a differential voltage across both ends of the shunt resistor Rs, amplifies the voltage by a predetermined gain with an amplifier part using a differential amplifier circuit, and outputs the voltage as a voltage drop signal Vout in the shunt resistor Rs. The delay circuit 61 smoothens the voltage drop signal Vout with a circuit composed of a resistor R3 and a capacitor C3, and outputs the signal to the control circuit 1 as the current detection signal Vm corresponding to the current flowing through the shunt resistor Rs. The bidirectional current detection circuit 60 is configured to be able to detect the positive and negative voltage drops generated at the shunt resistor Rs, i.e., to measure the bidirectional current by applying a voltage offsetting the output of the amplifier to a positive terminal of an OPAMP. Note that the voltage offsetting the output of the amplifier is not limited to Vdc/2, and the voltage offsetting the output of the amplifier may be applied to a negative terminal of the OPAMP.

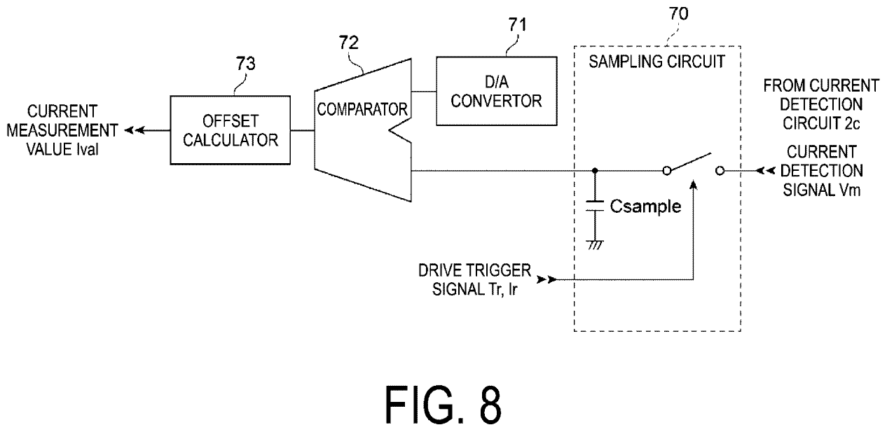

FIG. 8 is a diagram illustrating an example of a configuration of a current measurement unit 16 included in the control circuit 1 of the motor drive control device 10. The current measurement unit 16 includes a sampling circuit 70, a D/A converter 71, a comparator 72, and an offset calculator 73.

The current measurement unit 16 in FIG. 8 performs, at a predetermined timing, A/D conversion on the current detection signal Vm input from the current detection circuit 2c and corresponding to the current flowing through the shunt resistor Rs, and further performs offset adjustment described below, thereby generating a current measurement value Ival to be used in the control circuit 1. The current measurement value Ival is a value corresponding to the current flowing through the shunt resistor Rs of the current detection circuit 2c.

Specifically, the sampling circuit 70 in FIG. 8 is composed of, for example, a switch and a capacitor, and performs A/D conversion on the current detection signal Vm being the output voltage of the current detection circuit 2c, at a predetermined timing by turning the switch on and off in response to a drive trigger signal Tr, Ir output from a timing adjustment unit 15 or a state control unit 12 described below of the control circuit 1. The A/D conversion is performed through sampling by the sampling circuit 70, and quantization by the D/A converter 71 and the comparator 72. A value generated through the A/D conversion is further subjected to offset adjustment described below by the offset calculator 73, and thus the current measurement value Ival corresponding to the current flowing through the shunt resistor Rs is generated. During driving of the motor, the current measurement value Ival is used in a vector control unit 13 as the current measurement values Iu, Iv and Iw. In addition, during idling detection of the motor, the current measurement value Ival is used in an idling determination unit 22 of the state control unit 12 described below of the control circuit 1.

During driving of the motor, the control circuit 1 generates the drive control signal Sd for driving the motor 3 based on, for example, the speed command signal Sc input from the outside and indicating a target operation state of the motor 3, and controls driving of the motor 3. Specifically, the control circuit 1 generates the drive control signal Sd such that the motor 3 is set to an operation state designated by the speed command signal Sc, and provides the drive control signal to the drive circuit 2.

During idling detection of the motor, the control circuit 1 also generates the idling control signal Id described below instead of the drive control signal Sd and detects idling of the motor 3. Specifically, the control circuit 1 generates the idling control signal Id such that each of the switching elements Q1 to Q6 of the inverter circuit 2a is set to a switch state designated by the idling control signal Id, and provides the idling control signal to the drive circuit 2.

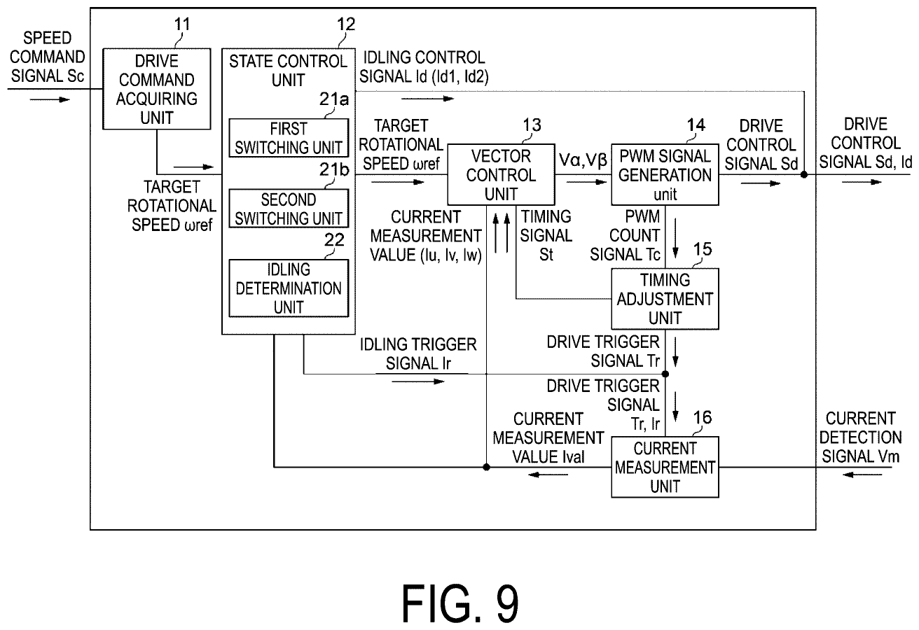

Further, during idling detection of the motor, the state control unit 12 described below generates the idling trigger signal Ir, and generates the current measurement value Ival from the current detection signal Vm detected in the current detection circuit 2c. Specifically, the state control unit 12 generates the idling trigger signal Ir for turning on the switch of the sampling circuit 70 at a predetermined timing, and provides the idling trigger signal to the current measurement unit 16. Note that although not specifically illustrated in FIG. 9, the state control unit 12 may further include a function unit for executing such processing.

In the embodiment, the control circuit 1 is a program processing device (for example micro controller) having a configuration with a processor such as a CPU, various storage devices such as a RAM and a ROM, and a peripheral circuit, such as a counter (timer), an A/D conversion circuit, a D/A conversion circuit, a clock generation circuit, and an input/output I/F circuit, connected to each other via a bus or a dedicated line, for example.

Note that the motor drive control device 10 may have a configuration with at least a part of the control circuit 1 and at least a part of the drive circuit 2 packaged as one integrated circuit device (IC), or a configuration with the control circuit 1 and the drive circuit 2 packaged as individual respective integrated circuit devices.

FIG. 9 is a diagram illustrating a functional block configuration of the control circuit 1 in the motor drive control device 10 according to the embodiment.

As illustrated in FIG. 9, the control circuit 1 includes a drive command acquiring unit 11, the state control unit 12, a vector control unit 13, a PWM signal generation unit 14, a timing adjustment unit 15, and the current measurement unit 16, as functional blocks for generating the drive control signal Sd during driving of the motor by vector control, for example. In addition, the control circuit 1 includes the state control unit 12 and the current measurement unit 16, as functional blocks for generating the idling control signal Id during idling detection of the motor. The state control unit 12 includes a first switching unit 21a, a second switching unit 21b, and an idling determination unit 22.

These functional blocks are implemented when the processor executes various arithmetic processing in accordance with the programs stored in the memory and controls the peripheral circuit such as the counter and the A/D conversion circuit in the program processing device serving as the control circuit 1, for example.

By receiving the speed command signal Sc from the outside and analyzing the received speed command signal Sc, the drive command acquiring unit 11 acquires a value for designating a target operation state of the motor 3 designated by the speed command signal Sc.

The speed command signal Sc includes a value indicating the target operation state of the motor 3. The speed command signal Sc is a signal output from a higher-level device for controlling the motor unit 100 provided outside the motor drive control device 10, for example.

In the embodiment, the speed command signal Sc designates a rotational speed of the rotor of the motor 3, for example. The speed command signal Sc includes a value ωref of a rotational speed (target rotational speed) serving as a target of the rotor of the motor 3.

The speed command signal Sc is a PWM signal with a duty ratio corresponding to the designated target rotational speed ωref, for example. The drive command acquiring unit 11 measures the duty ratio of the PWM signal of the speed command signal Sc, and outputs a rotational speed corresponding to the measured duty ratio as the target rotational speed ωref, for example.

The state control unit 12 outputs the target rotational speed ωref as is to the vector control unit 13 during driving of the motor. The state control unit 12 can determine how to start the motor when an idling determination signal described below is generated from the idling determination unit 22. Note that although not specifically illustrated in FIG. 9, the state control unit 12 may further include a function unit for executing such processing.

The vector control unit 13 generates voltage values Vα and Vβ from the target rotational speed ωref and the current measurement value Ival in accordance with known vector control, and outputs the values to the PWM signal generation unit 14 (space vector modulation (SVM) circuit). At this time, the current measurement value Ival is subjected to offset adjustment described below, and is treated as the current measurement values Iu, Iv, and Iw depending on the measurement timing relative to the drive control signal Sd.

The PWM signal generation unit 14 outputs the drive control signal Sd to the drive circuit 2 to control the drive circuit 2 in a PWM manner, and also outputs a PWM count signal Tc to the timing adjustment unit 15, the PWM count signal Tc being a signal indicating the start of PWM counting in the PWM control.

The timing adjustment unit 15 starts a timing generation counter in synchronization with the start of PWM counting, and triggers the current measurement unit 16. Specifically, the timing adjustment unit 15 outputs a drive trigger signal Tr to the current measurement unit 16 at a current capture timing based on the PWM count signal Tc output from the PWM signal generation unit 14.

The current measurement unit 16 performs A/D conversion on the current detection signal Vm corresponding to the currents Iu, Iv, and Iw on the basis of the drive trigger signal Tr, and further performs offset adjustment described below to generate the current measurement value Ival. The current measurement value Ival is output to the vector control unit 13, and the vector control unit 13 performs vector control from the current values of the three phases on the basis of the timing signal St from the timing adjustment unit 15, and calculates a magnitude of energization in the PWM signal generation unit 14.

During idling detection of the motor, the state control unit 12 outputs the idling trigger signal Ir for turning on the switch of the sampling circuit 70 at a predetermined timing to the current measurement unit 16 to instruct measurement of the current detection signal Vm, and performs A/D conversion on the input current detection signal Vm and further performs offset adjustment described below to generate the current measurement value Ival.

Now, the offset adjustment is described. During driving of the motor and idling detection of the motor, the current detection circuit 2c can measure the current flowing in both directions at the shunt resistor Rs, so the voltage drop signal Vout at the shunt resistor Rs and the current detection signal Vm are offset by Vdc/2, in the bidirectional current detection circuit 60 of the current detection circuit 2c. As a result, in the current measurement unit 16, the current measurement value Ival is set to a value other than zero in the state where no current flows through the shunt resistor Rs. When the current measurement value Ival in the state where no current flows through the shunt resistor Rs is set to zero through the offset adjustment, the same current measurement as the current measurement of the known ground direction (a direction from the inverter circuit 2a toward the ground) is achieved, and further the current direction is clarified with positive and negative signs.

For the offset adjustment, the state control unit 12 performs A/D conversion on the current detection signal Vm input to the current measurement unit 16 in the free mode or the charging mode as the state where no current flows through the shunt resistor Rs, acquires an offset value in advance, and uses the acquired offset value in the offset calculator 73 of the current measurement unit 16.

Specifically, in the free mode (the initial first switch state) or the charging mode (the second switch state), the state control unit 12 outputs the idling trigger signal Ir for turning on the switch of the sampling circuit 70 of the current measurement unit 16, performs A/D conversion on the current detection signal Vm input from the current detection circuit 2c, and specifies, as an offset value, a current measurement value generated by deactivating the offset calculator 73. Generating the current measurement value by deactivating the offset calculator 73 may be repeated multiple times, and an average value of the current measurement values generated multiple times may be set as the offset value. In the free mode or the charging mode, no current flows through the shunt resistor Rs of the current detection circuit 2c regardless of the presence/absence of the idling state of the motor, and therefore the current detection signal Vs detected at this time can be used as the reference of the current zero, and can be set as the offset used when generating the current measurement value Ival.

The offset adjustment may be performed immediately after power-on, in the free mode immediately after the input of the speed command signal Sc, or, in the charging mode after the input of the speed command signal Sc.

During idling detection of the motor, in the discharge mode, i.e., when the state is switched from the second switch state to the first switch state, the state control unit 12 outputs the idling trigger signal Ir for turning on the switch of the sampling circuit 70 at a predetermined timing to the current measurement unit 16 to instruct measurement of the input current detection signal Vm, and performs A/D conversion on the input current detection signal Vm and further performs offset adjustment to generate the current measurement value Ival. The current measurement unit 16 outputs the generated current measurement value Ival to the idling determination unit 22 of the state control unit 12.

The idling determination unit 22 determines whether the motor 3 is idling, based on the current measurement value Ival generated by the current measurement unit 16, and generates an idling determination signal representing a determination result of idling. Specifically, the idling determination unit 22 compares an idling threshold value set in advance and the current measurement value Ival generated by the current measurement unit 16, and determines that the motor 3 is idling when the maximum current measurement value Ival at the minus side being the inverter circuit direction side exceeds the threshold value and is smaller than the idling threshold value (has a large negative value).

When the motor 3 is idling, the inductive kickback is generated at a timing of switching to the discharge mode, and a current flows from the ground side toward the inverter circuit 2a side. When the motor 3 is idling at a high speed, the induced voltage and the induced current increase, resulting in an increase in the duration of the inductive kickback and an increase in the current flowing through the shunt resistor Rs in the inverter circuit direction, and this is used for the determination. The idling determination unit 22 can employ, as the idling threshold value, the value in a range from the current measurement value (small negative value) of the current flowing through the shunt resistor Rs due to the inductive kickback when the motor 3 is stopped, to the current measurement value (large negative value) corresponding to the current flowing through the shunt resistor Rs due to the inductive kickback when idling at the minimum rotation speed, for example.

In the state control unit 12, the first switching unit 21a generates a first idling control signal Id1 for switching the switching elements Q1 to Q6 constituting the inverter circuit 2a to the first switch state. In the state control unit 12, the second switching unit 21b generates a second idling control signal Id2 for switching the switching elements Q1 to Q6 constituting the inverter circuit 2a to the second switch state. The first and second idling control signals Id generated by the first switching unit 21a and the second switching unit 21b of the state control unit 12 are output to the drive circuit 2.

To set the switch state enabling the idling detection, the state control unit 12 generates the first idling control signal Id1 corresponding to the free mode by the first switching unit 21a until the speed command signal Sc is received in the drive command acquiring unit 11 after power-on. Thereafter, during a charging time (a period corresponding to the charging mode), the state control unit 12 generates the second idling control signal Id2 by the second switching unit 21b. Further thereafter, during a discharge time (a period corresponding to the discharge mode), the state control unit 12 generates the first idling control signal Id1 again by the first switching unit 21a. Note that after the discharge time, the first idling control signal Id1 corresponding to the free mode may be generated by the first switching unit 21a.

The shift timing from the free mode to the charging mode may be after the drive command acquiring unit 11 has received the speed command signal Sc, for example.

The charging time can be set to 10 times a time constant defined by inductance and winding resistance of the coils of the motor 3. Since the coils of the motor 3 have winding resistance and inductance, they can be regarded as an RL series circuit, and the time required for the winding current to be stabilized is 10 times the time constant. For example, when the winding resistance is 0.44Ω and the inductance is 0.4333 mH, the time constant is 1 ms. In this case, the charging time may be 10 ms. The longer the charging time, the clearer the distinction of stoppage and idling of the motor at a low rotation speed; however, the charging time is preferably short because the inspection period for the idling detection is shortened.

During the discharge time, the current flowing through the shunt resistor Rs in the inverter circuit direction due to the inductive kickback converges to zero due to attenuation, and therefore the discharge time only needs to be a time equal to or longer than the time constant of the delay circuit 61 in the current detection circuit 2c. If the maximum current in the inverter circuit direction can be measured, the presence or absence of the idling state of the motor can be determined, and thus the discharge time can be regarded as being reached. In addition, the discharge time may be set to a time equal to or longer than 0.5 times the time constant defined by the winding resistance and inductance of the coils of the motor 3. The reason for this is that 0.5 times the time constant is a timing when the current flowing through the shunt resistor Rs in the inverter circuit direction converges to about 60% of the peak time due to attenuation, but in the discharge mode, it is sufficient if the maximum current in the inverter direction in the shunt resistor Rs can be detected. For example, when the winding resistance is 0.44Ω and the inductance is 0.4333 mH, the time constant is 1 ms. In this case, the discharge time is 0.5 ms.

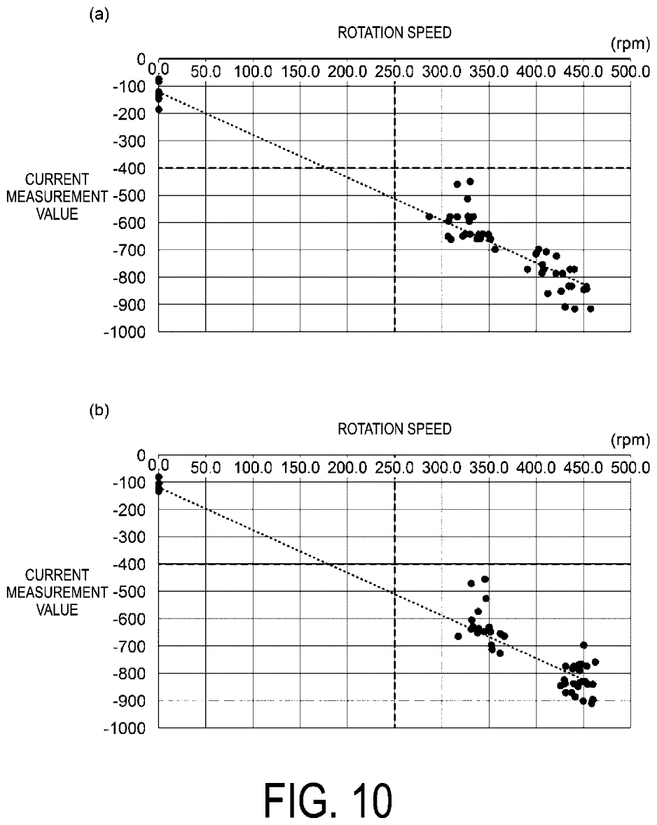

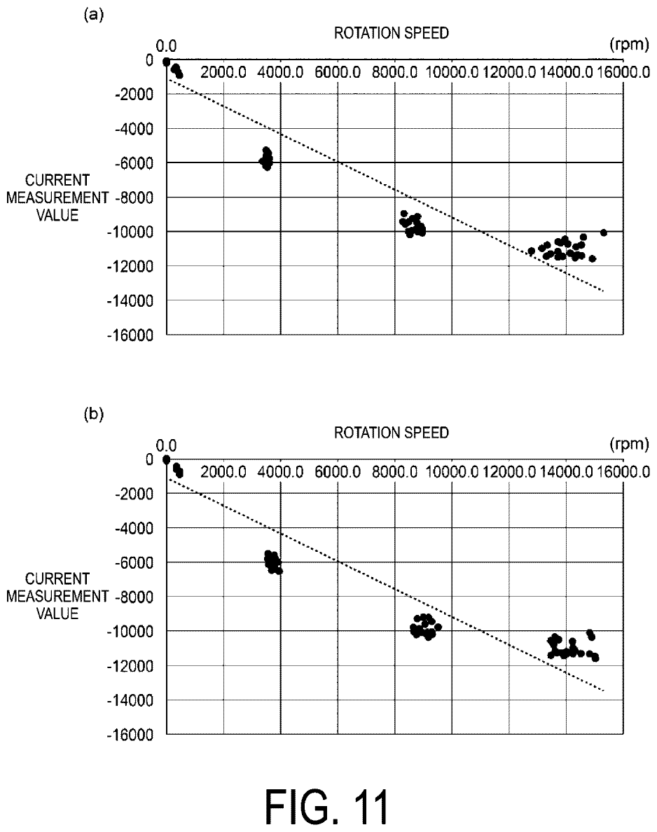

FIGS. 10 and 11 are diagrams illustrating a relationship between the rotation speed of the motor 3 and the current measurement value generated by the current measurement unit 16 with respect to the current flowing through the shunt resistor due to the inductive kickback. In (a) of FIGS. 10 and 11, the charging time (period corresponding to the charging mode) is 50 msec, and in (b) of FIGS. 10 and 11, the charging time (period corresponding to the charging mode) is 10 msec.

FIG. 10 shows a case where the rotor of the motor 3 is idling in a low-speed range during the charging time (a period corresponding to the charging mode), and FIG. 11 shows a case where the rotor of the motor 3 is idling in a high-speed range. In FIGS. 10 and 11, the vertical axis represents the current measurement value generated by the current measurement unit 16 with respect to the current flowing through the shunt resistor due to the inductive kickback, and the horizontal axis represents the rotation speed (rpm) of the motor 3. At this time, the current measurement value is subjected to offset adjustment.

FIGS. 10 and 11 show the current measurement values generated by the current measurement unit 16 with respect to the current flowing through the shunt resistor due to the inductive kickback observed at each rotation speed of the motor 3. The current measurement value is a negative (−) value because the current flows from the ground side toward the inverter circuit 2a side in the shunt resistor Rs. According to FIGS. 10 and 11, whether the charging time is 10 msec or 50 msec, similarly, the current measurement value and the motor rotation speed are in a substantially proportional relationship within a wide range of the rotation speeds of the motor 3. Note that it can be said that the rotation is substantially stopped at 250 rpm or less. In addition, in the case of idling at about 300 rpm, the current measurement value is less than-400, whether the charging time is 10 msec or 50 msec. Therefore, it can be understood that the current flowing through the shunt resistor due to the inductive kickback does not depend on the charging time, and the idling can be sufficiently detected if the charging time is 10 msec.

Next, the transition of the mode after power-on of the state control unit 12 will be described in detail.

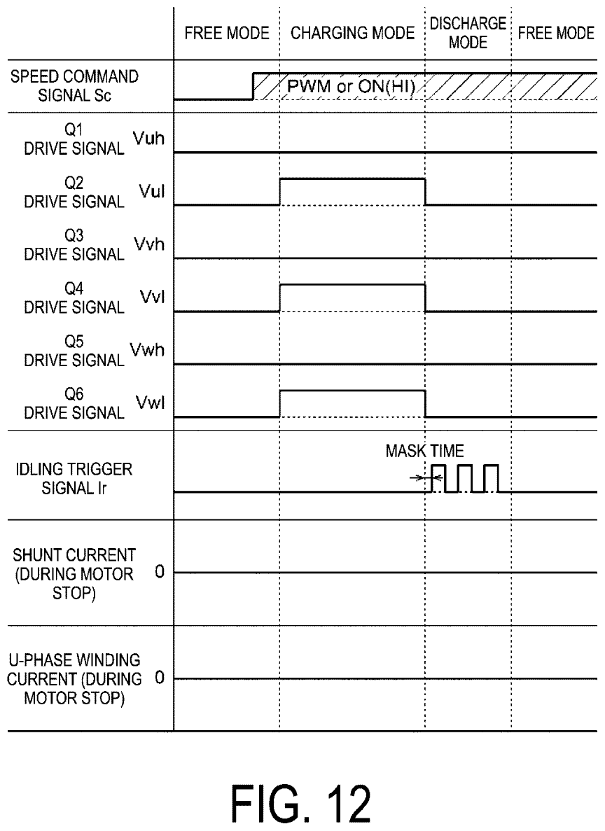

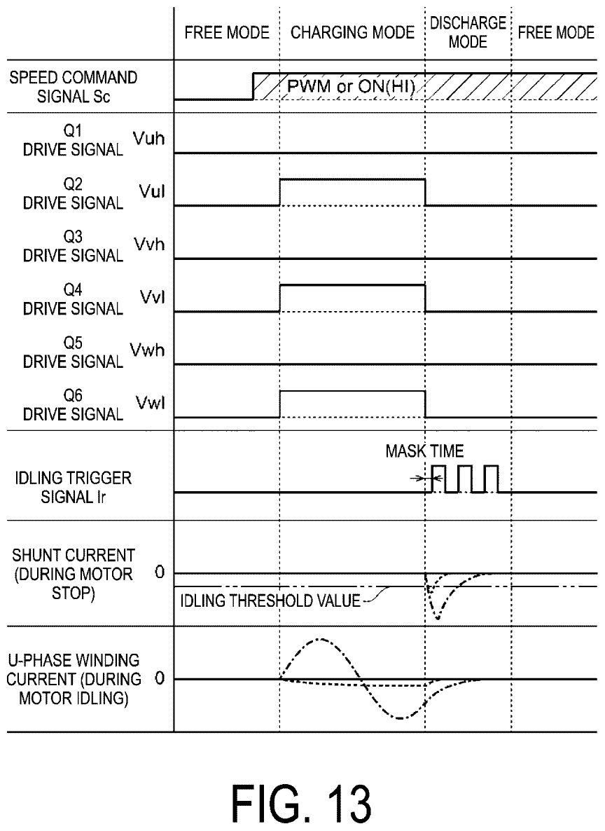

FIGS. 12 and 13 are timing charts illustrating an example of a signal waveform until the speed command signal Sc is input and the determination of idling is completed, after power-on of the motor unit 100. FIG. 12 is a timing chart when the rotor of the motor 3 is not moving at all, and FIG. 13 is a timing chart when the rotor of the motor 3 is moving (idling).

FIGS. 12 and 13 illustrate, from the upper side, waveforms of the speed command signal Sc, drive signals input to the gates of the switching elements Q1 to Q6, the idling trigger signal Ir for controlling the switching of the sampling circuit 70 in the current measurement unit 16, the shunt current Is detected at the shunt resistor Rs of the current detection circuit 2c, and the U-phase winding current. Note that the shunt current Is is a current flowing through the shunt resistor Rs of the current detection circuit 2c, and is a current corresponding to the current detection signal Vm.

As illustrated in FIGS. 12 and 13, the motor drive control device 10 is set to the free mode, the charging mode, and the discharge mode, and then returned to the free mode again. At this time, the motor drive control device 10 starts from the free mode after power-on. Note that the mode is set to the free mode again after the discharge mode in the timing charts illustrated in FIGS. 12 and 13 as an example, but this is not limitative.

In the free mode, the inverter circuit 2a is set to the first switch state by the idling control signal Id1. Specifically, all of the drive signals input to the gates of the switching elements Q1 to Q6 constituting the inverter circuit 2a are set to the low level by the idling control signal Id1, and thus all of the switches of the inverter circuit 2a are turned off. In this state, the closed circuit is not formed between the coils of the motor 3 and the inverter circuit 2a, regardless of the presence or absence of the idling state of the motor, and thus the current of the coils of the motor 3 becomes zero. In addition, no current flows through the shunt resistor Rs.

In addition, in the examples in FIGS. 12 and 13, in the free mode, the idling trigger signal Ir for measuring the shunt current Is is at the low level. However, in this period, the idling trigger signal Ir may be set to the high level at a predetermined timing. In this case, the current measurement unit 16 can acquire the current detection signal Vm output from the current detection circuit 2c, and can treat the signal as an offset because no current flows through the shunt resistor Rs.

Next, in the charging mode, the inverter circuit 2a is set to the second switch state by the idling control signal Id2. Specifically, all of the drive signals input to the gates of the switching elements Q2, Q4 and Q6 of the lower arms of the switching elements Q1 to Q6 constituting the inverter circuit 2a are set to the high level by the idling control signal Id2, and thus all of the low-side switches of the inverter circuit 2a are turned off.

In this state, when the rotor of the motor 3 is not moving at all, no current flows through the coils of the motor 3 and the shunt resistor Rs as in the free mode, as illustrated in FIG. 12. On the other hand, when the rotor of the motor 3 is moving, an induced voltage is generated in the coils of the motor 3, and a closed circuit is formed by the coils of the motor 3 and the switching elements Q2, Q4, and Q6 turned on in the inverter circuit 2a as illustrated in FIG. 13, so that a current circulating between the coils of the motor 3 and the inverter circuit 2a is generated and a current corresponding to the rotation of the motor flows through the windings, while at this time, no current flows through the shunt resistor Rs because the shunt resistor is not included in the closed circuit.

In addition, in the examples in FIGS. 12 and 13, in the charging mode, the idling trigger signal Ir for measuring the shunt current Is is at the low level. However, in this period, the high level may be set at a predetermined timing. In this case, the current measurement unit 16 can acquire the current detection signal Vm output from the current detection circuit 2c, and can treat the signal as an offset because no current flows through the shunt resistor Rs. Note that in the case where the offset is acquired in the free mode, the offset may not be acquired at this timing again.

Next, in the discharge mode, the inverter circuit 2a is again set to the first switch state by the idling control signal Id1. Specifically, all of the drive signals input to the gates of the switching elements Q1 to Q6 constituting the inverter circuit 2a are set to the low level by the idling control signal Id1, and thus all of the switches of the inverter circuit are turned off.

In this state, when the rotor of the motor 3 is moving, the current circulating between the coils of the motor 3 and the inverter circuit 2a intends to continuously flow through the coils in this period, and thus the inductive kickback is generated due to all of the switching elements being turned off. Due to this inductive kickback, in the shunt resistor Rs, the current increasing in the direction of the inverter circuit 2a (inverter circuit direction) from the ground side is momentarily generated and converges to zero. At this time, it can be determined that the rotor of the motor 3 is idling although the rotating direction of the motor 3 cannot be determined, by detecting the current flowing through the shunt resistor Rs with the current detection circuit 2c, and measuring the maximum current in the inverter circuit direction through continuous measurement with the current measurement unit 16.

In addition, in the discharge mode, after a predetermined mask time, the idling trigger signal Ir for measuring the shunt current Is becomes the high level at a predetermined timing. The predetermined mask time is set as a period for removing switching noise of the inverter circuit 2a due to the drive signal being off. After the predetermined mask time, the current measurement unit 16 acquires the current detection signal Vm output from the current detection circuit 2c, and measures the current flowing through the shunt resistor Rs.

FIG. 13 illustrates the shunt current Is and the U-phase winding current in two states. When the rotation speed of the idling is low, in the charging mode, the amplitude of the U-phase winding current (dotted line) is small, a small shunt current (dotted line) is generated at the minus side being the inverter circuit direction side due to the inductive kickback in the discharge mode, and the current flowing in the inverter circuit direction of the shunt resistor Rs is small. On the other hand, when the rotation speed of the idling is high, in the charging mode, the amplitude of the U-phase winding current (dashed-dotted line) is large, a large shunt current (dashed-dotted line) is generated at the minus side due to the inductive kickback in the discharge mode, and the current flowing in the inverter circuit direction of the shunt resistor Rs is large. In both cases, the maximum current of the shunt current Is observed in the inverter circuit direction is larger than the idling threshold value (dashed double-dotted line) for determining the idling, and therefore the idling is determined.

Next, the flow of idling determination processing by the control circuit 1 of the motor drive control device 10 according to the embodiment will be described.

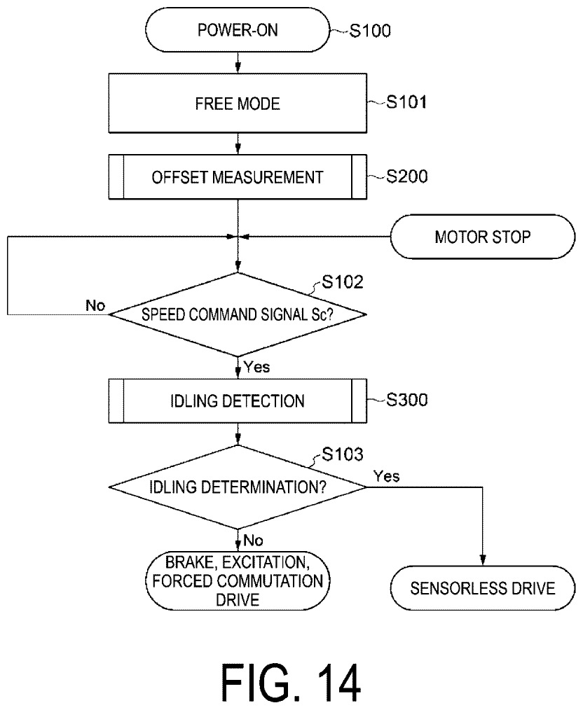

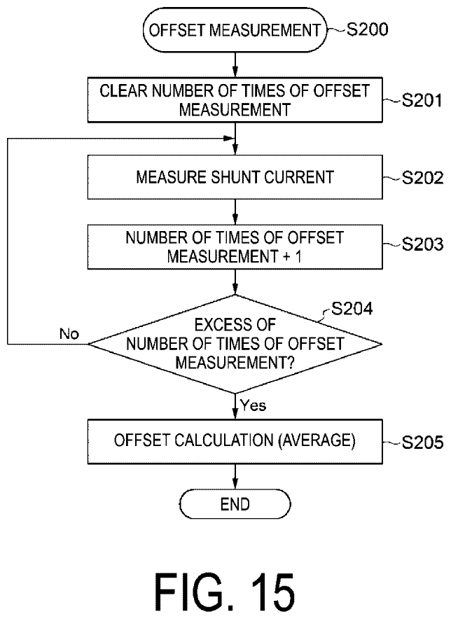

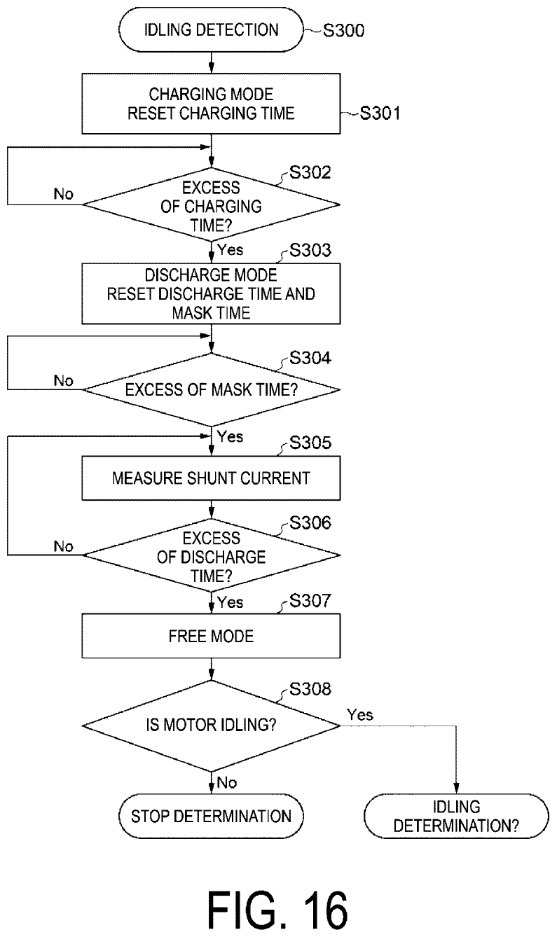

FIG. 14 is a flowchart illustrating an example of the flow of processing upon power-on in the control circuit 1 of the motor drive control device 10 according to the embodiment. FIG. 15 is a flowchart illustrating an example of the flow of offset measurement processing by the control circuit 1 of the motor drive control device 10. FIG. 16 is a flowchart illustrating an example of the flow of idling detection processing by the control circuit 1 of the motor drive control device 10.

First, when the power is turned on in the motor drive control device 10, as illustrated in FIG. 14, in the state control unit 12, the first switching unit 21a generates the first idling control signal Id1 for switching to the first switch state so as to set the switching elements Q1 to Q6 constituting the inverter circuit 2a to the switch state corresponding to the free mode (step S101).

In accordance with the first idling control signal Id1 generated in step S101, the state control unit 12 generates the idling control signal Id1 for switching the switching elements Q1 to Q6 constituting the inverter circuit 2a to the first switch state. In response to the idling control signal Id1, the switching elements Q1 to Q6 constituting the inverter circuit 2a enter the first switch state as illustrated in FIG. 2.

Next, the state control unit 12 executes offset measurement processing (step S200).

When the state control unit 12 starts the offset measurement processing, first, the state control unit clears the offset measurement counter and deactivates the offset calculator 73 as illustrated in FIG. 15 (step S201).

Next, the state control unit 12 outputs the idling trigger signal Ir to switch the sampling circuit 70 of the current measurement unit 16, and performs A/D conversion on the current detection signal Vm output from the current detection circuit 2c to generate the current measurement value Ival corresponding to the current flowing through the shunt resistor Rs (step S202). Note that the shunt current Is at this time is zero, but with the voltage offsetting the amplifier of the bidirectional current detection circuit 60, the current measurement value Ival is set to a value other than zero.

When the shunt current measurement of step S202 is completed, the state control unit 12 increments the offset measurement counter by “+1” (step S203).

The state control unit 12 determines whether the number of times the current offset measurement is performed exceeds a predetermined number of times the offset measurement is performed by confirming the offset measurement counter (step S204).

When the number of times the current offset measurement is performed does not exceed the predetermined number of times the offset measurement is performed (step S204: No), the processing is returned to step S202. On the other hand, when the number of times the current offset measurement is performed exceeds the predetermined number of times the offset measurement is performed (step S204: Yes), the average value of the values acquired in the measurement of step S202 is acquired as the offset value, and the offset calculator 73 is activated (step S205).

Returning to FIG. 14, after the offset measurement of step S200, the state control unit 12 determines whether the drive command acquiring unit 11 has received the speed command signal Sc from a higher-level device (step S102).

When it is determined that the speed command signal Sc has not been received (step S102: No), the determination of step S102 is performed again after a predetermined time has elapsed as is.

When it is determined that the speed command signal Sc has been received (step S102: Yes), idling detection processing is executed (step S300).

In the idling detection processing of step S300, the switch state is already the first switch state corresponding to the free mode, so the second switching unit 21b in the state control unit 12 first generates the second idling control signal Id2 for switching to the second switch state corresponding to the charging mode, as illustrated in FIG. 16 (step S301). At this time, in the state control unit 12, the charging time is reset.

In accordance with the second idling control signal Id2 generated in step S301, the state control unit 12 generates the idling control signal Id2 for switching the switching elements Q1 to Q6 constituting the inverter circuit 2a to the second switch state. In response to the idling control signal Id, the switching elements Q1 to Q6 constituting the inverter circuit 2a enter the second switch state as illustrated in FIG. 3, for example.

In the state control unit 12, the second switching unit 21b determines whether the predetermined charging time has elapsed after the second idling control signal Id2 is generated in step S301 (step S302).

When the second switching unit 21b in the state control unit 12 determines that the predetermined charging time elapses after the second idling control signal Id2 is generated (step S302: Yes), the first switching unit 21a in the state control unit 12 generates the first idling control signal Id1 for switching to the first switch state corresponding to the discharge mode (step S303). At this time, in the state control unit 12, the discharge time and the mask time are reset.

The state control unit 12 switches the switching elements Q1 to Q6 constituting the inverter circuit 2a to the first switch state by generating the first idling control signal Id1 generated in step S303. That is, in response to the idling control signal Id1, the switching elements Q1 to Q6 constituting the inverter circuit 2a enter again the first switch state as illustrated in FIG. 4, for example.

The state control unit 12 determines whether the mask time has elapsed (step S304). When the mask time elapses (step S304: Yes), the state control unit 12 executes shunt current measurement processing (step S305).

In the shunt current measurement processing of step S305, the state control unit 12 outputs the idling trigger signal Ir to the current measurement unit 16 to switch the sampling circuit 70 of the current measurement unit 16, and performs A/D conversion on the current detection signal Vm output from the current detection circuit 2c and further performs the offset adjustment to generate the current measurement value Ival. The current measurement unit 16 outputs the current measurement value Ival to the idling determination unit 22 of the state control unit 12. The current measurement value Ival corresponds to the current flowing through the shunt resistor Rs of the current detection circuit 2c.

The state control unit 12 determines whether the discharge time has elapsed (step S306). When the discharge time elapses (step S306: Yes), the state control unit 12 ends the shunt current measurement processing and thus enters the free mode (step S307). On the other hand, when the discharge time has not elapsed (step S306: No), the state control unit 12 again executes the shunt current measurement processing (step S305).

The idling determination unit 22 determines whether the motor 3 is idling based on the maximum current measurement value in the inverter circuit direction generated by the current measurement unit 16 (step S308). The idling determination unit 22 compares the maximum current measurement value in the inverter circuit direction and the idling threshold value to determine whether the motor 3 is idling, in step S308. The idling determination unit 22 may convert the current measurement value Ival generated with respect to the current detection signal Vm received from the current measurement unit 16 into an actual current value and then compare the actual current value with the current value of the threshold value, or may compare the current measurement value Ival generated from the current detection signal Vm received from the current measurement unit 16 without offset adjustment with the threshold value without offset adjustment.

The idling determination unit 22 determines that the motor 3 is idling, when the maximum current measurement value at the minus side being the inverter circuit direction side exceeds the threshold value and is smaller than the idling threshold value (has a large negative value) (step S308: Yes).

The idling determination unit 22 determines that the motor 3 is stopped (not idling), when the maximum current measurement value at the minus side being the inverter circuit direction side exceeds the idling threshold value (has a large negative value) (step S308: No). The idling determination unit 22 generates an idling determination signal indicating the idling determination result. The idling determination signal is used by the state control unit 12.

Returning to FIG. 14, the state control unit 12 determines, from the generated idling determination signal, whether the motor 3 was determined to be idling (step S103), and when determined to be idling (step S103: YES), outputs the target rotational speed ωref to the vector control unit 13 and executes motor driving by vector control. On the other hand, when determined to be not idling (step S103: No), the state control unit 12 executes motor driving by braking, excitation, and forced commutation start, or the like.

The control circuit 1 of the motor drive control device 10 according to the embodiment, when the rotor of the motor 3 is idling, generates the induced current circulating between the coils of the motor 3 and the inverter circuit 2a by switching the switch states of the respective switching elements Q1 to Q6 of the inverter circuit 2a, and then determines that the motor 3 is idling based on the current flowing through the shunt resistor Rs due to the inductive kickback generated in the inverter circuit when the path of the induced current is blocked.

This enables the motor drive control device 10 to accurately detect the presence or absence of the idling state of the motor 3 in a short time without using a position sensor or a measurement circuit for each phase voltage.

In addition, in the motor drive control device 10 according to the embodiment, the control circuit 1 includes the first switching unit 21a configured to switch from the first switch state with all of the high-side switches and the low-side switches included in the inverter circuit turned off to the second switch state with at least two of either the high-side switches or the low-side switches included in the inverter circuit turned on, the second switching unit 21b configured to switch from the second switch state to the first switch state, and the idling determination unit 22 configured to determine that the motor is idling, based on the current flowing through the shunt resistor when switching from the second switch state to the first switch state is performed.

This enables each of the switching elements Q1 to Q6 of the inverter circuit 2a to switch to the respective switch states corresponding to the three modes (free mode, charging mode, discharge mode) for detecting the idling of the motor 3, thereby allowing detection of the presence or absence of the idling state of the motor 3.

In addition, in the motor drive control device 10 according to the embodiment, the second switching unit switches from the second switch state to the first switch state when a time ten times the time constant defined by the winding resistance and inductance of the motor elapses.

This enables a time during which the idling can be sufficiently detected to be set as the charging time (the period of the switch state corresponding to the charging mode).

In addition, in the motor drive control device 10 according to the embodiment, after switching from the second switch state to the first switch state, the first switching unit maintains the first switch state for a time until the current flowing through the shunt resistor due to the inductive kickback becomes a maximum current in the inverter circuit direction from the ground toward the inverter circuit or for a time equal to or more than 0.5 times the time constant defined by the winding resistance and inductance of the motor.

This enables a time during which the idling can be sufficiently detected to be set as the discharge time (the period of the switch state corresponding to the discharge mode) because the maximum current flowing through the shunt resistor Rs in the inverter direction can be measured even if the detection is ended at a timing when a detected value converges to about 60% of the peak value due to attenuation.

In addition, in the motor drive control device 10 according to the embodiment, the control circuit determines that the motor is idling when the maximum current flowing through the shunt resistor in the inverter circuit direction due to the inductive kickback exceeds a predetermined threshold value.

This enables the reliable determination that the motor is idling, by adopting, as the determination of the idling, the current in the range from the current flowing through the shunt resistor Rs due to the inductive kickback when the motor 3 is stopped to the current flowing through the shunt resistor Rs due to the inductive kickback when the motor 3 is idling at the minimum rotation speed.

In addition, the motor drive control device 10 according to the embodiment further includes the current detection circuit 2c including the shunt resistor and the bidirectional current detection circuit capable of detecting the current flowing through the shunt resistor in both the ground direction from the inverter circuit toward the ground and the inverter circuit direction, and the control circuit further includes the current measurement unit 16 configured to detect in advance, as an offset, a signal output from the current detection circuit in a state where no current flows through the shunt resistor, to adjust, with the offset, a signal output from the current detection circuit in determination of the idling and to output the signal to the idling determination unit.

In this manner, even when the current flowing through the shunt resistor Rs is a negative current, the value can be detected.

### Expansion of Embodiments

The invention made by the present inventor has been specifically described above based on the embodiments, but the present invention is not limited to the embodiments, and it goes without saying that the present invention can be changed in various ways within the scope not departing from the gist of the present invention.

In addition, the case example where the speed command signal Sc includes the target value (target rotational speed) of the rotational speed of the motor 3 has been described in the embodiment, but this is not limitative. For example, the speed command signal Sc may be a torque command signal for designating the torque of the motor 3.

In addition, the description has been given based on the example where the motor drive control device 10 does not use a position sensor or a measurement circuit for each phase voltage in the embodiment, but a position sensor and/or a measurement circuit for each phase voltage may be provided. Also in this case, the position sensor and the measurement circuit for each phase voltage need not be used for detecting the idling. As the position sensor, a Hall element configured to output Hall signals may be used, or other signals corresponding to the rotation position of the rotor of the motor 3 may be input as the rotation position detection signal instead of such Hall signals. For example, an encoder, a resolver, or the like may be provided such that the detection signal is input to the control circuit 1. In addition, the measurement circuit for each phase voltage may be configured such that a signal of an A/D converter or a comparator configured to compare each phase voltage and a neutral point voltage is input as the rotation position detection signal.

In addition, in the embodiment, the control circuit 1 is not limited to the above-described circuit configuration. The control circuit 1 may employ various circuit configurations configured to achieve the objects of the present invention.

Specifically, in the current measurement unit 16, an idling determination circuit using a comparator instead of the sampling circuit 70 may be provided such that a signal of an idling threshold value is output from a D/A converter so as to determine that the motor is idling when the maximum current detection signal Vm in the inverter circuit direction exceeds the idling threshold value, and output the idling determination signal to the state control unit 12.

In addition, in the embodiment, the charging mode and the discharge mode may be repeated periodically to detect whether the motor is idling and to cause the motor to wait to stop in the discharge mode while allowing the motor to be in a short braking state by the charging mode.

In addition, in the embodiment, the driving of the motor is not limited to sinusoidal driving.

The number of phases of the motor 3 driven by the motor drive control device 10 in the embodiment is not limited to 3 phases.

The above-described flowcharts are specific examples, and the flowcharts are not limitative. For example, other processing may be inserted between the steps, and the processing may be executed in parallel.

### REFERENCE SIGNS LIST

1 . . . Control circuit, 2 . . . Drive circuit, 2a . . . Inverter circuit, 2b . . . Pre-drive circuit, 2c . . . Current detection circuit, 3 . . . Motor, 10 . . . Motor drive control device, 11 . . . Drive command acquiring unit, 12 . . . State control unit, 13 . . . Vector control unit, 14 . . . PWM signal generation unit, 15 . . . Timing adjustment unit, 16 . . . Current measurement unit, 21a . . . First switching unit, 21b . . . Second switching unit, 22 . . . Idling determination unit, 60 . . . Bidirectional current detection circuit, 61 . . . Delay circuit, 70 . . . Sampling circuit, 71 . . . D/A converter, 72 . . . Comparator, 73 . . . Offset calculator, 100 . . . Motor unit, Q1 to Q6 . . . Switching element, Rs . . . Shunt resistor, Sc . . . Speed command signal, Sd . . . Drive control signal, Id . . . Idling control signal, Tr . . . Drive trigger signal, Ir . . . Idling trigger signal, Vm . . . Current detection signal, Ival . . . Current measurement value, ωref . . . Target rotational speed, Vα, Vβ . . . Voltage value, Tc . . . PWM count signal, St . . . Timing signal, Vdc, Vin . . . DC power supply, Vuu, Vul, Vvu, Vvl, Vwu, Vwl . . . Drive signal, Vout . . . Voltage drop signal.

1. A motor drive control device comprising:
a control circuit configured to generate a drive control signal for driving a motor comprising at least one phase of coil;
a drive circuit comprising an inverter circuit comprising a high-side switch and a low-side switch, the high-side switch and the low-side switch being provided corresponding to each phase of coil of the motor and connected in series with each other, the drive circuit being configured to rotate a rotor of the motor by alternately turning on and off the high-side switch and the low-side switch in response to the drive control signal and thus switching an energization direction of the corresponding phase of coil; and
a shunt resistor provided between the inverter circuit and a ground, wherein
the control circuit generates an idling control signal instead of the drive control signal and switches a switch state of the inverter circuit, and thus generates an induced current circulating between each phase of coil of the motor and the inverter circuit when the rotor of the motor is idling, and then determines that the motor is idling, based on a current flowing through the shunt resistor due to an inductive kickback generated in the inverter circuit when a path of the induced current is blocked.

2. The motor drive control device according to claim 1, wherein
the control circuit is configured to:
switch from a first switch state with all of the high-side switches and the low-side switches included in the inverter circuit turned off, to a second switch state with at least two of either the high-side switches or the low-side switches included in the inverter circuit turned on;
switch from the second switch state to the first switch state; and
determine that the motor is idling, based on the current flowing through the shunt resistor when switching from the second switch state to the first switch state is performed.

3. The motor drive control device according to claim 2, wherein the control circuit switches from the second switch state to the first switch state when a time elapses that is ten times a time constant defined by a winding resistance and an inductance of the motor.

4. The motor drive control device according to claim 2, wherein after switching from the second switch state to the first switch state, the control circuit maintains the first switch state for a time until the current flowing through the shunt resistor due to the inductive kickback becomes a maximum current in an inverter circuit direction from the ground toward the inverter circuit, or for a time equal to or more than 0.5 times a time constant defined by a winding resistance and an inductance of the motor.

5. The motor drive control device according to claim 4, wherein the control circuit determines that the motor is idling when the maximum current flowing through the shunt resistor in the inverter circuit direction due to the inductive kickback exceeds a predetermined threshold value.

6. The motor drive control device according to claim 4, further comprising a current detection circuit comprising the shunt resistor and a bidirectional current detection circuit configured to detect the current flowing through the shunt resistor in both a ground direction from the inverter circuit toward the ground and the inverter circuit direction, wherein
the control circuit is further configured to:
detect in advance, as an offset, an output signal from the current detection circuit while no current flows through the shunt resistor; and
adjust, with the offset, a signal output from the current detection circuit in determination of the idling.

7. A method for detecting idling of a motor to be executed in a motor drive control device, the motor drive control device comprising a control circuit configured to generate a drive control signal for driving a motor comprising at least one phase of coil; a drive circuit comprising an inverter circuit comprising a high-side switch and a low-side switch, the high-side switch and the low-side switch being provided corresponding to each phase of coil of the motor and connected in series with each other, the drive circuit being configured to rotate a rotor of the motor by alternately turning on and off the high-side switch and the low-side switch in response to the drive control signal and thus switch an energization direction of the corresponding phase of coil; and a shunt resistor provided between the inverter circuit and a ground, the method comprising:
a first step of switching from a first switch state with all of the high-side switches and the low-side switches included in the inverter circuit turned off to a second switch state with at least two of either the high-side switches or the low-side switches included in the inverter circuit turned on;
a second step of switching from the second switch state to the first switch state; and
a third step of determining that the motor is idling, based on a current flowing through the shunt resistor when switching to the first switch state is performed.
